(19) United States
(12) Patent Application Publication
(10) Pub. No.: US 2013/0316831 A1
(43) Pub. Date: Nov. 28, 2013

(54) REAL-TIME, INTERACTIVE APPLICATION OVER HTML WEB SOCKETS

(71) Applicant: Sanjay Noronha, Cupertino, CA (US)

(72) Inventor: Sanjay Noronha, Cupertino, CA (US)

(73) Assignee: Mixiedust, Inc.

(21) Appl. No.: 13/477,930

(22) Filed: May 22, 2012

(51) Int. Cl. G06F 15/16; A63F 9/24

(52) U.S. Cl. 463/42

(57) ABSTRACT

A real-time, interactive application for use with multiple clients utilizing web sockets is disclosed.

### BACKGROUND OF THE INVENTION

Web servers are well-known in the prior art. FIG. 1 depicts a typical prior art web server 10. Web server 10 can communicate with exemplary clients 21 and 22 over the Internet 30. Web server 10, client 21, and client 22 are coupled to the Internet 30 over links 50. Web server 10 typically comprises a software web server, such as Apache, running on a hardware server. Client 21 can be any computer with network connectivity, such as a mobile handset, tablet, notebook, desktop, or server. Links 50 can be hardwired or wireless. Web server 10 and clients 21 and 22 can communicate using any one of numerous known communication protocols, including HTTP. HTTP is a ubiquitous protocol that is used in a substantial portion of Internet communication is the primary protocol used by web browsers such as Internet Explorer, Firefox, Chrome, and Safari.

In the prior art, HTTP permitted only limited real-time communication between two clients such as client 21 and client 22. Internet messaging, texting, email, and voice and video telephony are some of the applications that utilized HTTP communication, each of which utilized web server 10 as an intermediary. Those communications, however, often involved a series of one-way HTTP communications that were coordinated by the underlying software application, such as Yahoo Instant Messenger. HTTP was not originally designed to facilitate real-time, interactive communication. Although consumers are willing to accept noticeable delays in applications such as Internet messaging, other applications that required a greater degree of instantaneous communication—such as video games—were not well-suited for HTTP communication. Thus, to date, there has been limited or no availability of video games and other applications that require a relatively high degree of instantaneous communication over HTTP

The prior art also included Adobe Flash, which was software that permitted interaction between a client and web server. However, Adobe Flash was a proprietary technology and is not currently supported by certain web browsers, such as Safari. It also is not available at all on certain mobile handsets, such as the Apple iPhone and iPad.

Recently, the W3C organization proposed “The WebSocket API,” dated Dec. 8, 2011, which is incorporated herein by reference. The WebSocket API is intended to be offered as part of the HTML 5 specification, which at this time is in draft form also. The draft HTML specification and The WebSocket API introduce a new technology called “web sockets.” Web sockets facilitate full-duplex communication between server and client.

What is needed is an improved method and apparatus for real-time, interactive communication involving two or more clients and a web server in a manner that utilizes web sockets.

### SUMMARY OF THE INVENTION

The aforementioned problems and needs are addressed by providing an application running on a web server that provides interaction with one or more clients using web sockets.

Other objects and features of the present invention will become apparent by a review of the specification, claims, and appended figures.

### BRIEF DESCRIPTION OF THE DRAWINGS

FIG. 1 is an exemplary block diagram of a prior art web browser and clients.

FIG. 2 is an exemplary block diagram of an embodiment that enables a real-time, interactive application involving a web browser and clients.

FIG. 3 is a depiction of an exemplary lobby web page.

FIG. 4 is a depiction of an updated version of the exemplary lobby web page shown in FIG. 3.

FIG. 5 is a sequence of images displayed by two clients interacting with a web server.

### DETAILED DESCRIPTION OF THE PREFERRED EMBODIMENTS

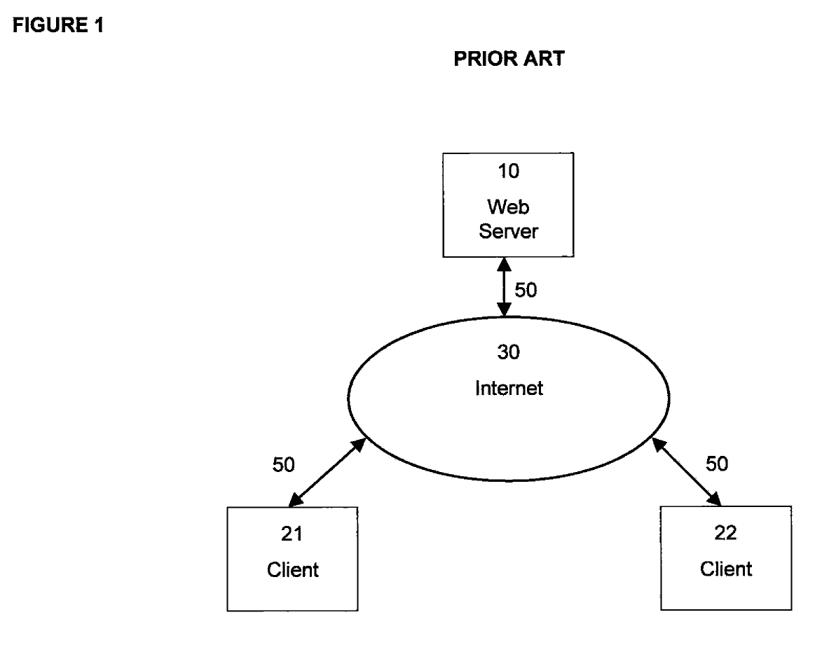

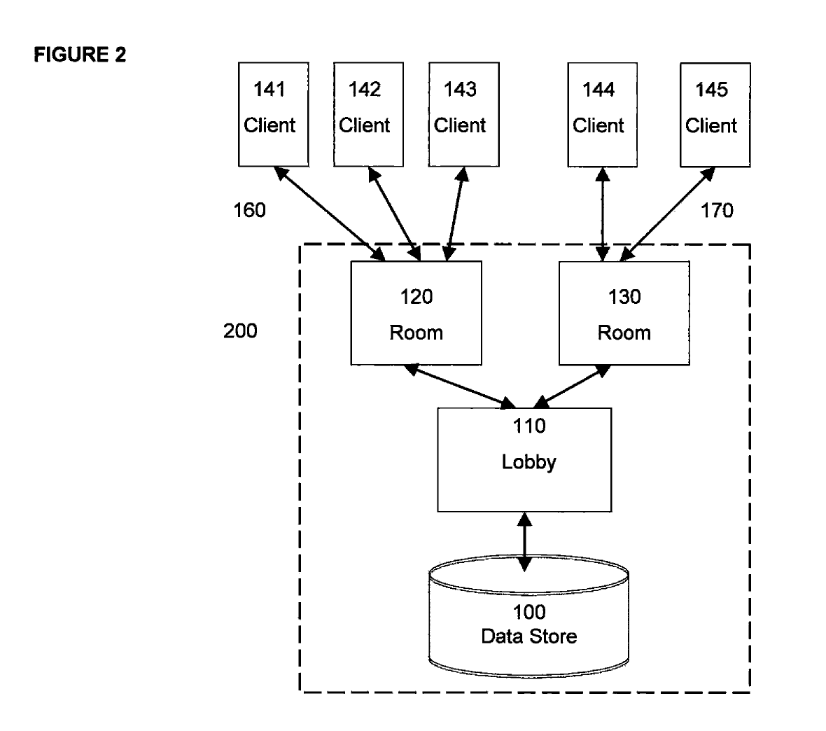

An embodiment is now described with reference to FIG. 2. Web server 200 comprises a software web server, such as Apache, running on a hardware server. The software web server utilized by web server 200 optionally complies with The WebSocket API. Web server 200 communicates with a plurality of exemplary clients 141, 142, 143, 144, and 145, which each can comprise any computer with network connectivity, such as a mobile handset, tablet, notebook, desktop, or server. Web server 200 can communicate with exemplary clients 141, 142, 143, 144, and 145 over the Internet (not shown) using links (not shown) of the type shown in FIG. 1.

In this embodiment, web server 200 further comprises data store 100. Data store 100 optionally can comprise a relational database such as MySQL. Web browser 200 creates lobby data structure 110. Lobby data structure 110 is related to the lobby web page 210 (discussed below), which a user can visually see on his or her web browser.

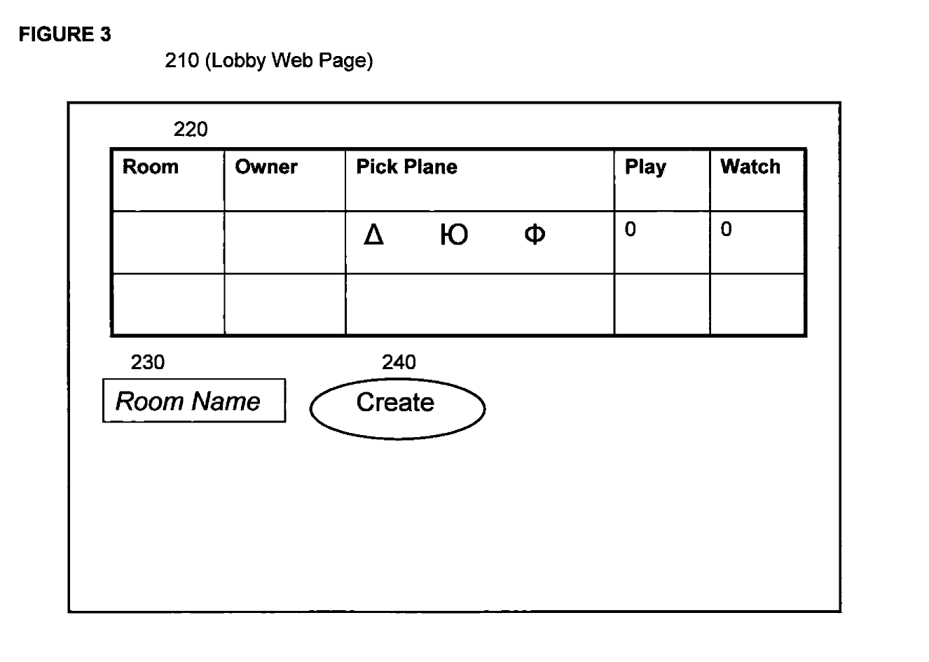

Client 141 initiates communication with web browser 200 by typing in a URL for a website maintained by web browser 200. With reference now to FIG. 3, web server 200 optionally generates lobby web page 210, which comprises an HTML file sent from web browser 200 to client 141 and which is opened by the web browser running on client 141. Lobby web page 210 includes user interface features such as table 220, text box 230, and button 240. In this example, table 220 displays the active room, the owner of each room, an option for new users to pick a plane, and the number of users playing in the room and watching in the room. Text box 230 allows the user of client 141 to create a new room by typing in a name for the room in text box 230. If the user does so (such as by entering the words “Brent's Room”), he or she presses button 240 to cause the browser on client 141 to transmit the information from text box 230 to web server 200. Thereafter, web server 200 will create a room as requested by client 141.

With reference now to both FIGS. 2 and 3, in response to these actions by client 141, web server 200 will generate room data structure 120. Client 141 optionally can then invite other clients, such as clients 142 and 143, to join room 120 or web server 200 can simply add clients, such as clients 142 and 143, to room 120 as they contact web server 200. In this example, client 142 joins room 120 to play, and client 143 joins room 120 to watch.

In this example, clients 141, 142, and 143 communicate with web server 200 using web socket 160. Under the HTML 5 Specification, once web socket 160 is established, data frames within web socket 160 can be sent back and forth between clients 142, 142, and 143 and web server 200 in full-duplex mode. Room data structure 120 exchanges data in certain instances with lobby data structure 110.

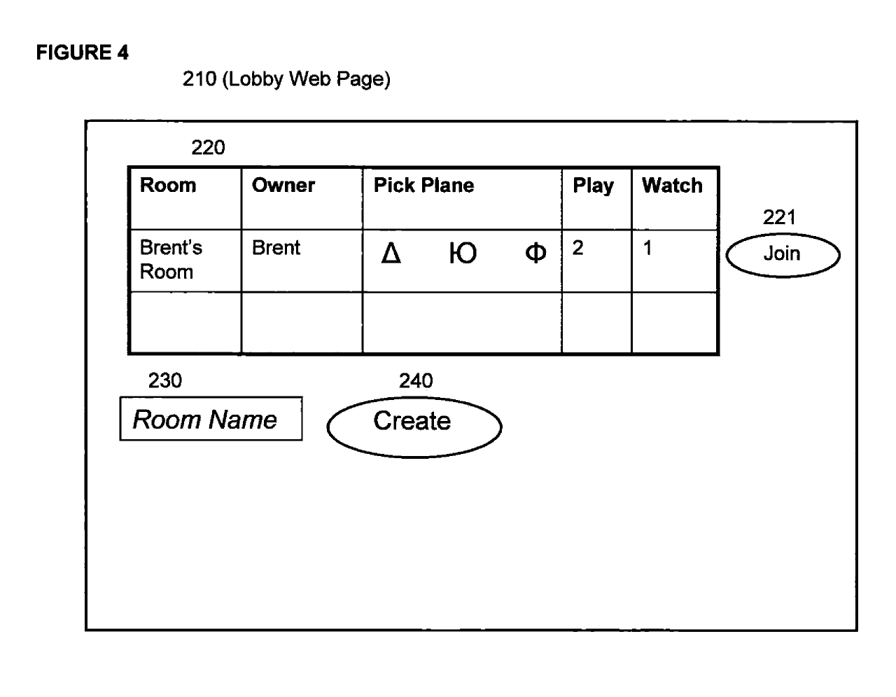

If another client accesses lobby web page 210, lobby web page 210 now will reflect the current status of room 120. This is shown in FIG. 4, where table 220 now shows the existence of room 120 (named “Brent's Room”) and indicates that two users are playing and one is watching. Because room 120 now exists, lobby web page 210 optionally can display a “join” button 221 next to the row in table 220 describing room 120 so that new users can joint room 120.

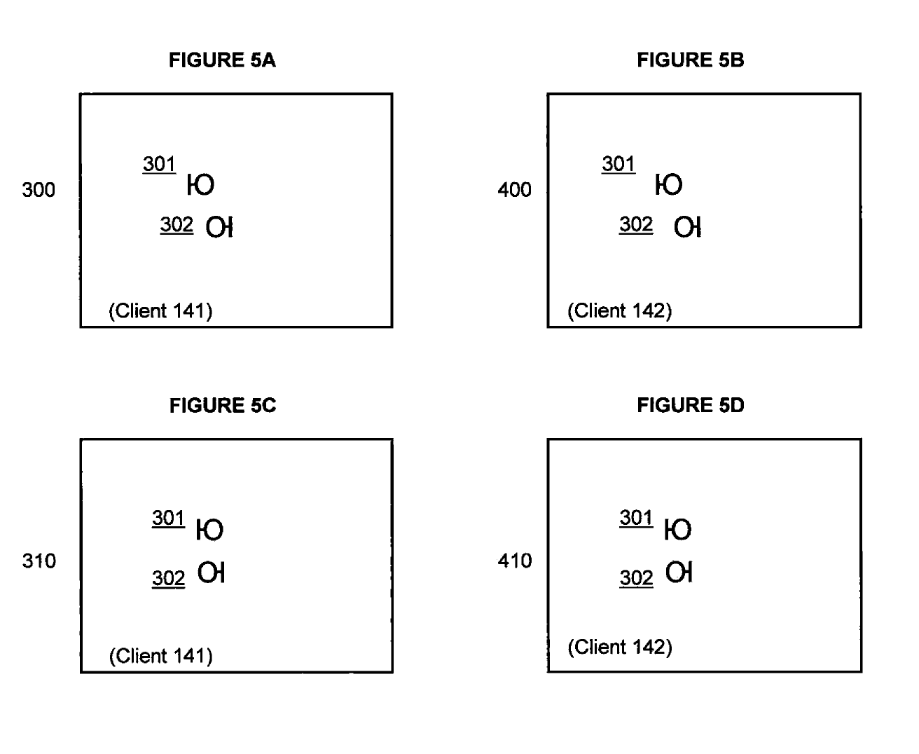

With reference now to FIGS. 5A, 5B, 5C, and 5D, an example of one application is now shown. Room 120 can facilitate an interactive video game. In FIGS. 5A, 5B, 5C, and 5D, an interactive airplane video game is depicted. FIG. 5A shows screen 300 that is viewed on the web browser of client 141 at time t. FIG. 5B shows screen 400 that is viewed on the web browser of client 142 at time t. In FIGS. 5A and 5B, object 301 is a graphics icon representing the airplane controlled by client 141, and object 302 is a graphics icon representing the airplane controlled by client 142. In this example, at time t, the user of client 141 provides an instruction to client 141 for object 301 to stay in place, and the user of client 142 provides an instruction to client 142 for object 302 to continue on its path. These instructions can be provided through any well-known means of user interface, such as by using a mouse, keyboard, touch screen, etc. Client 141 maintains a local data structure 305 that reflects the state of client 141 at time t. Local data structure 305 can include information such as command received. Client 142 also maintains a local data structure 405 that reflects the state of client 142 at time t and can include information such as command received. Clients 141 and 142 then communicate with web server 200 using web socket 160 to indicate the changes in state. In this example, they each would communicate the commands received from the users.

Web server 200 then will update room data structure 120 to reflect the new state. In this example, room data structure includes data for object 301 and object 302 that is indicative of their relative placement on the screen (for example, by using X and Y coordinates to indicate pixel location). After the update, web server 200 will communicate the new state to clients 141 and 142 using web socket 160, and clients 141 and 142 thereafter will update the web browser display.

FIG. 5C shows screen 310 that is viewed on the web browser of client 141 at time t+Δ, and FIG. 5D shows screen 410 that is viewed on the web browser of client 142 at time t+Δ. Here, Δ is an increment of time that indicates the amount of time between screen refreshes, such as 250 ms. As shown in FIGS. 5C and 5D, the relative positions of object 301 and object 302 have changed in response to the user commands. Notably, both screens reflect the changes in real-time. Optionally, the graphics generation is performed locally by clients 141 and 142 and does not require the transmission of bandwidth-consuming graphics data with each change in state.

In this example, client 143 has elected to only watch and not play. Client 143 therefore will generate a display identical to those shown in FIGS. 5A and 5C (or 5B and 5D), and the user of client 143 will be able to watch the game just as the users of clients 141 and 142 do. Web server 200 sends the same state information to client 143 over web socket 160 as it sends to clients 141 and 142 over web socket 160.

Optionally, state information is communicated between web server 200 and clients 141 and 142 only when a change in state has occurred. Thus, the system is event-driven and does not require polling, which minimize the amount of network communication required.

With reference again to FIG. 2, another exemplary room with clients is shown, room 130 and clients 144 and 145. Room 120 and room 130 exchange a subset of state information with lobby 110. For example, room 120 and 130 might send lobby 110 the following information:

Exit of a player from a room

Entry of a player into a room

New high score in a game

New level reached in a game

Current scores of all players in room

Lobby 110 might send room 120 the following information:

Name of new player

Number of slots remaining for additional players

Graphic icon selected by each player (e.g. type of airplane)

Amount of time remaining (if each room has a time limit)

Optionally, data store 100 stores the lobby data and all room data.

References to the present invention herein are not intended to limit the scope of any claim or claim term, but instead merely make reference to one or more features that may be covered by one or more of the claims. Materials, processes and numerical examples described above are exemplary only, and should not be deemed to limit the claims. It should be noted that, as used herein, the terms “over” and “on” both inclusively include “directly on” (no intermediate materials, elements or space disposed there between) and “indirectly on” (intermediate materials, elements or space disposed there between). Likewise, the term “adjacent” includes “directly adjacent” (no intermediate materials, elements or space disposed there between) and “indirectly adjacent” (intermediate materials, elements or space disposed there between). For example, forming an element “over a substrate” can include forming the element directly on the substrate with no intermediate materials/elements there between, as well as forming the element indirectly on the substrate with one or more intermediate materials/elements there between.

1. A system for providing a multi-player interactive video game, comprising:
a web server comprising a data store;
a first client computer coupled to the web server using a first web socket, wherein the first client computer is configured to generate on a display and to control a first graphical icon representing a first player in the video game and to generate on the display a second graphical icon representing a second player in the video game;
a second client computer coupled to the web server using a second web socket, wherein the second client computer is configured to generate on a display the first graphical icon and to generate on a display and to control the second graphical icon;
wherein the data store comprises a data structure associated with the video game, and wherein the web server is configured to provide state information from said data structure to the first client computer over the first web socket and the second client computer over the second web socket, wherein the state information comprises location information for the first graphical icon and location information for the second graphical icon.

2. The system of claim 1, wherein the first web socket and second web socket each are compliant with the HTML 5 specification.

3. The system of claim 1, wherein the data store comprises a relational database.

4. The system of claim 1, wherein the first client computer is a mobile device.

5. The system of claim 4, wherein the second client computer is a desktop computer.

6. The system of claim 1, wherein the data structure comprises one or more of the following for the game:
number of players in the game;
name of players in the game;
icon used by each player in the game;
time remaining in the game; and
location of each player within the game;

7. The system of claim 1, wherein the first client computer comprises a first local data structure that can be changed based on commands received from the first client computer.

8. The system of claim 7, wherein the second client computer comprises a second local data structure that can be changed based on commands received from the second client computer.

9. (canceled)

10. (canceled)

11. A method for facilitating a multi-player interactive video game, comprising:
populating, on a web server, a data store with state information for a video game in real-time by a first user and a second user;
establishing a first web socket between the web server and a first client computer operated by the first user and a second web socket between the web server and a second client computer operated by the second user; and
providing, by the web server, state information to the first client computer over the first web socket and the second client computer over the second web socket, wherein the state information comprises location information for a first graphical icon controlled by the first client computer and location information for a second graphical icon controlled by the second client computer;
displaying the first graphical icon at a first location and the second graphical icon at a second location on a display of the first client computer and concurrently displaying the first graphical icon at the first location and the second graphical icon at the second location on a display of the second client computer.

12. The method of claim 11, wherein the first web socket and the second web socket each is compliant with the HTML 5 specification.

13. The method of claim 11, wherein the data store comprises a relational database.

14. The method of claim 11, wherein the first client computer is a mobile device.

15. The method of claim 14, wherein the second client computer is a desktop computer.

16. The method of claim 11, wherein the state information comprises one or more of the following types of information for the game:
number of players in the game;
name of players in the game;
icon used by each player in the game;
time remaining in the game; and
location of each player within the game;

17. The method of claim 11, wherein the first client computer creates a first local data structure that can be changed based on commands received from the first client computer.

18. The method of claim 17, wherein the second client computer creates a second local data structure that can be changed based on commands received from the second client computer.

19. (canceled)

20. (canceled)

21. The system of claim 1, further comprising a third client computer coupled to the web server using a third web socket, wherein the web server is configured to provide the state information to the third client computer over the third web socket and the third client computer is configured to generate on a display the first graphical icon and the second graphical icon and does not generate on the display a graphical icon controlled by the third client computer.

22. The system of claim 21, wherein the state information comprises information indicating that a user of the third client computer is watching but not playing the video game.

23. The method of claim 11, further comprising:
establishing a third web socket between the web server and a third client computer operated by a third user;
providing, by the web server, the state information to the third client computer over the third web socket,
displaying the first graphical icon at a first location and the second graphical icon at a second location on a display of the third client computer, where the display of the third client computer does not contain a graphical icon controlled by the third client computer.

24. The method of claim 23, wherein the state information comprises information indicating that a user of the third client computer is watching but not playing the video game.
